(19) United States
(12) Patent Application Publication
(10) Pub. No.: US 2025/0293296 A1
(43) Pub. Date: Sep. 18, 2025

(54) SOLID-STATE BATTERY

(71) Applicant: HONDA MOTOR CO., LTD., Tokyo (JP)

(72) Inventors: Kizashi IWAKIRI, Saitama (JP); Takuya TANIUCHI, Saitama (JP); Tomohiko TSUZAKI, Saitama (JP)

(21) Appl. No.: 19/008,653

(22) Filed: Jan. 3, 2025

(30) Foreign Application Priority Data
Mar. 18, 2024 (JP) 2024-042069

(51) Int. Cl. H01M 10/0562; H01M 10/0525; H01M 10/0585

(52) U.S. Cl. CPC H01M 10/0562; H01M 10/0525; H01M 10/0585

(57) ABSTRACT

Provided is a solid-state battery including: an electrode laminate in which a negative electrode, a solid electrolyte layer, and a positive electrode are sequentially laminated, wherein the solid electrolyte layer includes a first solid electrolyte layer and a second solid electrolyte layer, the first solid electrolyte layer being disposed on a side closer to the negative electrode, the second solid electrolyte layer being disposed on a side closer to the positive electrode, the positive electrode includes a positive electrode current collector and a positive electrode mixture layer, an inclined surface is formed at least at one end portion of the positive electrode mixture layer, and when the electrode laminate is viewed in a top view from a lamination direction of the electrode laminate, an outer peripheral part of the first solid electrolyte layer is located outward of an outer peripheral part of the positive electrode mixture layer.

This application is based on and claims the benefit of priority from Japanese Patent Application No. 2024-042069, filed on 18 Mar. 2024, the content of which is incorporated herein by reference.

### BACKGROUND OF THE INVENTION

### Field of the Invention

The present invention relates to a solid-state battery.

### Related Art

In recent years, to ensure access for a larger number of people to reliable advanced sustainable energy at reasonable prices, research and development has been conducted on solid-state batteries that contribute to energy efficiency.

With regard to solid-state batteries, there is a known all-solid-state battery in which a solid electrolyte layer is disposed between a positive electrode and a negative electrode.

Japanese Unexamined Patent Application, Publication No. 2022-144855 describes an all-solid-state battery that includes a positive electrode in which a positive electrode current collector layer and a positive electrode active material layer including at least a solid electrolyte are laminated, a negative electrode in which a negative electrode current collector layer and a negative electrode active material layer including at least a solid electrolyte are laminated, and a first solid electrolyte layer disposed between the positive electrode active material layer and the negative electrode active material layer. In the all-solid-state battery, the area of the negative electrode active material layer is larger than the area of the positive electrode active material layer when viewed in the direction perpendicular to the lamination direction, the area of the first solid electrolyte layer is larger than the area of the positive electrode active material layer when viewed in the direction perpendicular to the lamination direction, and a porosity n1ₐₘ of the positive electrode active material layer is 5% or less.

Japanese Unexamined Patent Application, Publication No. 2022-144855 also describes a method for manufacturing an all-solid-state battery, the method including a step of forming a positive electrode by applying a pressure to a positive electrode current collector layer and a positive electrode active material layer which are laminated, a step of forming a negative electrode by applying a pressure to a negative electrode current collector layer and a negative electrode active material layer which are laminated, and a step of forming a laminate unit by applying a pressure to the positive electrode, a first solid electrolyte layer, and the negative electrode which are laminated in this order.

Patent Document 1: Japanese Unexamined Patent Application, Publication No. 2022-144855

### SUMMARY OF THE INVENTION

However, in the method for manufacturing the all-solid-state battery described in Japanese Unexamined Patent Application, Publication No. 2022-144855, in applying a pressure to the positive electrode, the first solid electrolyte layer, and the negative electrode which are laminated in this order, there may be cases in which the first solid electrolyte layer moves inward to the end portion of the positive electrode active material layer, and comes into close contact with a positive electrode current collecting tab. In this case, the end portion of the positive electrode active material layer is constrained by the first solid electrolyte layer and hence, when a pressure is further applied, stresses are concentrated, thus causing cracks in the positive electrode active material layer and the first solid electrolyte layer. As a result, the capacity or the durability of the all-solid-state battery may be reduced.

It is an object of the present invention to provide a solid-state battery that can suppress occurrence of cracks in a positive electrode mixture layer and a solid electrolyte layer during manufacture.
(1) A solid-state battery including: an electrode laminate in which a negative electrode, a solid electrolyte layer, and a positive electrode are sequentially laminated, wherein the solid electrolyte layer includes a first solid electrolyte layer and a second solid electrolyte layer, the first solid electrolyte layer being disposed on a side closer to the negative electrode, the second solid electrolyte layer being disposed on a side closer to the positive electrode, the positive electrode includes a positive electrode current collector and a positive electrode mixture layer, and an inclined surface is formed at least at one end portion of the positive electrode mixture layer, and when the electrode laminate is viewed in a top view from a lamination direction of the electrode laminate, an outer peripheral part of the first solid electrolyte layer is located outward of an outer peripheral part of the positive electrode mixture layer.
(2) In the solid-state battery according to (1), when the electrode laminate is viewed in a top view from the lamination direction of the electrode laminate, an end portion of the positive electrode current collector on a side on which the inclined surface is formed is located outward of the outer peripheral part of the positive electrode mixture layer.
(3) In the solid-state battery according to (2), the second solid electrolyte layer is formed on a surface of the positive electrode current collector at a portion at which no positive electrode mixture layer is formed.
(4) In the solid-state battery according to any one of (1) to (3), the first solid electrolyte layer in a region where the first solid electrolyte layer faces a region of the positive electrode mixture layer having no inclined surface has a higher density than the first solid electrolyte layer in a region where the first solid electrolyte layer does not face the region of the positive electrode mixture layer having no inclined surface.
(5) In the solid-state battery according to any one of (1) to (4), the second solid electrolyte layer in a region where the second solid electrolyte layer does not face the region of the positive electrode mixture layer having no inclined surface has a higher density than the first solid electrolyte layer in the region where the first solid electrolyte layer does not face the region of the positive electrode mixture layer having no inclined surface.
(6) In the solid-state battery according to any one of (1) to (5), when the electrode laminate is viewed in a top view from the lamination direction of the electrode laminate, the outer peripheral part of the first solid electrolyte layer is located outward of an outer peripheral part of the second solid electrolyte layer.
(7) In the solid-state battery according to any one of (1) to (6), the solid-state battery is an all-solid-state lithium metal battery.

According to the present invention, it is possible to provide a solid-state battery that can suppress occurrence of cracks in the positive electrode mixture layer and the solid electrolyte layer during manufacture.

### BRIEF DESCRIPTION OF THE DRAWINGS

FIG. 1 is a cross-sectional view showing a solid-state battery according to one embodiment of the present invention;

FIG. 2 is a cross-sectional view showing a state of the solid-state battery shown in FIG. 1 at the time of performing pressing;

FIG. 3A and FIG. 3B are cross-sectional views showing a state of a solid-state battery at the time of performing pressing for a case in which inclinations are not formed at the end portions of the positive electrode mixture layers on a side on which a positive electrode current collecting tab extends;

FIG. 4 is a cross-sectional view showing a modification of the positive electrode shown in FIG. 1; and

FIG. 5 is a cross-sectional view illustrating a region A and regions B of the solid-state battery shown in FIG. 1.

### DETAILED DESCRIPTION OF THE INVENTION

Hereinafter, an embodiment of the present invention will be described with reference to drawings.

### Solid-State Battery

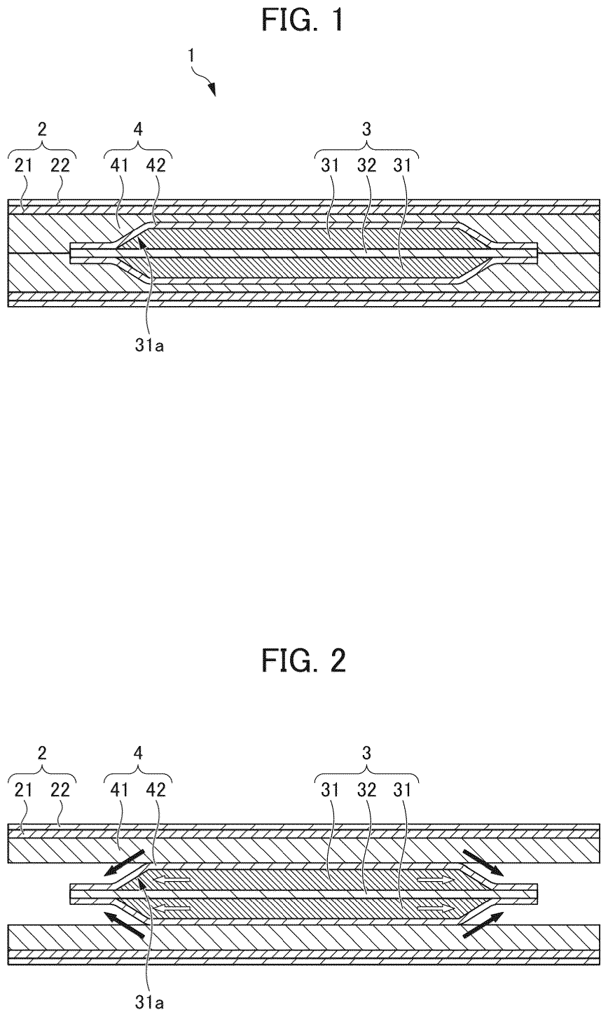

FIG. 1 shows a solid-state battery according to one embodiment of the present invention.

A solid-state battery 1 includes an electrode laminate in which a negative electrode 2, a solid electrolyte layer 4, a positive electrode 3, a solid electrolyte layer 4, and a negative electrode 2 are sequentially laminated. In the present embodiment, each solid electrolyte layer 4 includes a first solid electrolyte layer 41 and a second solid electrolyte layer 42, the first solid electrolyte layer 41 being disposed on the side closer to the negative electrode 2, the second solid electrolyte layer 42 being disposed on the side closer to the positive electrode 3. In the positive electrode 3, a positive electrode mixture layer 31, a positive electrode current collector 32, and a positive electrode mixture layer 31 are sequentially laminated in the lamination direction of the electrode laminate, and a positive electrode current collecting tab extends in the depth direction in the drawing, for example, from one end portion of the positive electrode current collector 32. In each negative electrode 2, a negative electrode mixture layer 21 and a negative electrode current collector 22 are sequentially laminated in the lamination direction of the electrode laminate, and a negative electrode current collecting tab extends toward the viewer's side in the drawing, for example, from the end portion of the negative electrode current collector 22 on a side opposite to the side on which the positive electrode current collecting tab extends.

The solid-state battery 1 is configured such that, when the electrode laminate is viewed in a top view from the lamination direction of the electrode laminate, the outer peripheral parts of the negative electrode mixture layers 21 and the first solid electrolyte layers 41 are located outward of the outer peripheral parts of the positive electrode current collector 32 and the second solid electrolyte layers 42. In this case, the outer peripheral parts of the negative electrode mixture layers 21 are located at positions substantially the same as the positions of the outer peripheral parts of the first solid electrolyte layers 41, and the outer peripheral parts of the positive electrode current collector 32 are located at positions substantially the same as the positions of the outer peripheral parts of the second solid electrolyte layers 42. Inclined surfaces are formed at end portions 31a of the positive electrode mixture layer 31 on both left and right sides in the drawing. Therefore, in manufacturing the electrode laminate by pressing the negative electrode 2, the solid electrolyte layer 4, the positive electrode 3, the solid electrolyte layer 4, and the negative electrode 2 which are sequentially laminated, the first solid electrolyte layers 41 gradually move inward to the inclined surfaces formed at the end portions 31a of the positive electrode mixture layers 31 (see FIG. 2). At this point of operation, elongation of the positive electrode mixture layers 31 and the second solid electrolyte layers 42 is not prevented and hence, the occurrence of cracks in the positive electrode mixture layers 31 and the solid electrolyte layers 4 is suppressed. As a result, a reduction in capacity and durability of the solid-state battery 1 is suppressed.

It is sufficient that the inclination be formed at least at one end portion of each positive electrode mixture layer 31. The inclination may be formed at all end portions of each positive electrode mixture layer 31, or may be formed at one end portion of each positive electrode mixture layer 31.

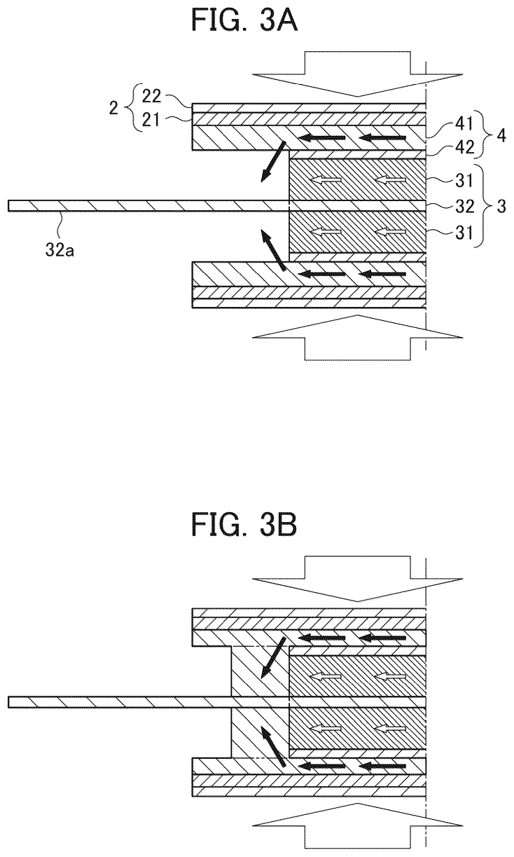

On the other hand, when the inclination is not formed at the end portion of each positive electrode mixture layer 31, in pressing the negative electrode 2, the solid electrolyte layer 4, the positive electrode 3, the solid electrolyte layer 4, and the negative electrode 2 which are sequentially laminated (see FIG. 3A), there may be cases in which the first solid electrolyte layers 41 move inward to the end portions of the positive electrode mixture layers 31 and the second solid electrolyte layers 42, and come into close contact with a positive electrode current collecting tab 32a (see FIG. 3B). In this case, the end portions of the positive electrode mixture layers 31 and the second solid electrolyte layers 42 are constrained by the first solid electrolyte layers 41 and hence, when pressing is further performed, stresses are concentrated, thus causing cracks in the positive electrode mixture layers 31 and the solid electrolyte layers 4.

Although not particularly limited, the angle of the inclination formed at the end portion of the positive electrode mixture layer 31 is, for example, 3° or more and 60° or less.

The solid-state battery 1 is configured such that, when the electrode laminate is viewed in a top view from the lamination direction of the electrode laminate, the end portion of the positive electrode current collector 32 on the side on which the inclined surfaces of the positive electrode mixture layers 31 are formed is located outward of the outer peripheral parts of the positive electrode mixture layers 31. Consequently, the first solid electrolyte layers 41 are easily moved gradually inward to the inclined surfaces formed at the end portions 31a of the positive electrode mixture layers 31.

Although not particularly limited, the area ratio of the positive electrode current collector 32 in a region where the positive electrode mixture layers 31 are not formed, at (one) end portion of the positive electrode current collector 32 on a side on which the inclined surfaces of the positive electrode mixture layers 31 are formed to the positive electrode current collector 32 in a region where the positive electrode mixture layers 31 are formed is, for example, 1/1000 or more and ⅕ or less.

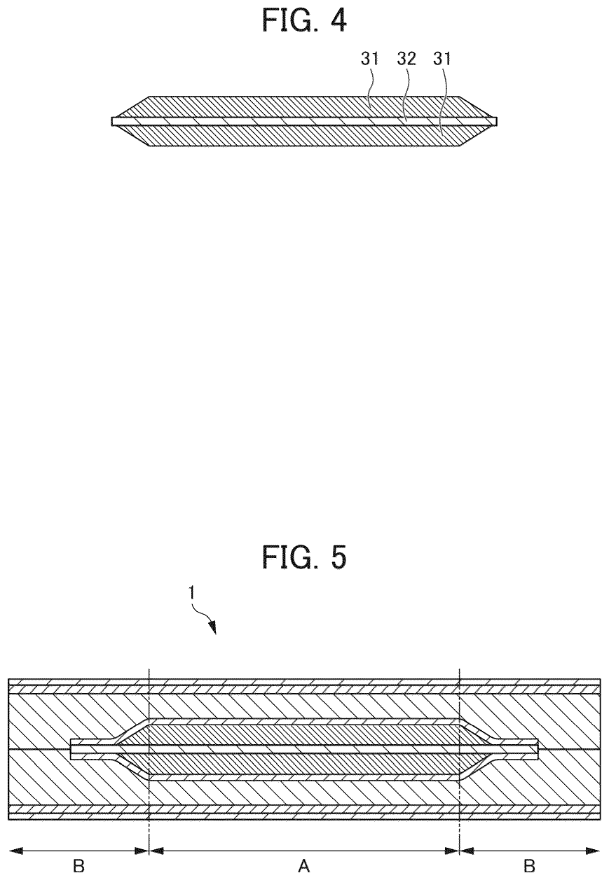

The solid-state battery 1 may be configured such that, when the electrode laminate is viewed in a top view from the lamination direction of the electrode laminate, the end portions of the positive electrode current collector 32 on the side on which the inclined surfaces of the positive electrode mixture layers 31 are formed are located at substantially the same positions as the end portions of the positive electrode mixture layers 31 on the side on which the inclined surfaces of the positive electrode mixture layers 31 are formed (see FIG. 4).

The second solid electrolyte layers 42 are formed on the surfaces of the positive electrode current collector 32 at portions at which the positive electrode mixture layers 31 are not formed. Consequently, short circuiting of the solid-state battery 1 is suppressed.

Due to a pressure applied in obtaining the electrode laminate by performing pressing described later, the first solid electrolyte layers 41 in a region A where the first solid electrolyte layers 41 face regions of the positive electrode mixture layers 31 having no inclined surfaces (see FIG. 5) have a higher density than the first solid electrolyte layers 41 in regions B where the first solid electrolyte layers 41 do not face the regions of the positive electrode mixture layers 31 having no inclined surfaces (see FIG. 5). The density of the second solid electrolyte layers 42 in the regions B is higher than the density of the first solid electrolyte layers 41 in the regions B.

Although not particularly limited, the density of the first solid electrolyte layers 41 in the region A is, for example, 0.5 g/cm³ or more and 6 g/cm³ or less. Although not particularly limited, the density of the first solid electrolyte layers 41 in the regions B is, for example, 95% or less of the density of the first solid electrolyte layers 41 in the region A. Although not particularly limited, the thickness of the first solid electrolyte layer 41 in the region A is, for example, 1 μm or more and 500 μm or less.

Although not particularly limited, the density of the second solid electrolyte layers 42 in the region A is, for example, 0.5 g/cm³ or more and 6 g/cm³ or less. Although not particularly limited, the density of the second solid electrolyte layers 42 in the regions B is 105% or more of the density of the first solid electrolyte layers 41 in the regions B. Although not particularly limited, the thickness of the second solid electrolyte layer 42 in the region A is, for example, 1 μm or more and 500 μm or less.

The configuration of the solid-state battery 1 is not particularly limited provided that the solid-state battery 1 includes the electrode laminate in which the negative electrode 2, the solid electrolyte layer 4, and the positive electrode 3 are sequentially laminated. For example, the solid-state battery 1 may include a plurality of positive electrodes 3. Alternatively, the solid-state battery 1 may include a single negative electrode 2 and a single solid electrolyte layer 4. In this case, in the positive electrode 3, the positive electrode mixture layer 31 and the positive electrode current collector 32 are sequentially laminated in the lamination direction of the electrode laminate.

### Method for Manufacturing Solid-State Battery

Next, a method for manufacturing the solid-state battery 1 will be described.

### First Solid Electrolyte Layer—Negative Electrode Laminate

A material for forming the first solid electrolyte layer 41 is disposed on the surface of the negative electrode 2 on the side on which the negative electrode mixture layer 21 is disposed, and then pressing is performed in this state to obtain a first solid electrolyte layer—negative electrode laminate. Although not particularly limited, an example of a method for disposing the material for forming the first solid electrolyte layer 41 on the surface of the negative electrode 2 on the side on which the negative electrode mixture layer 21 is disposed is a method in which the first solid electrolyte layer 41 is transferred onto the negative electrode mixture layer 21 by using a first solid electrolyte layer transfer sheet. The first solid electrolyte layer transfer sheet is obtained in such a manner that a solid electrolyte having a median size of 1 μm or less, for example, is dispersed in a solvent to obtain a slurry, and the slurry is applied to a support sheet and, thereafter, is dried. Although not particularly limited, a pressing pressure is, for example, 10 MPa or more and 2000 MPa or less. Although not particularly limited, a pressing temperature is, for example, room temperature or more and 200° C. or less.

### Second Solid Electrolyte Layer—Positive Electrode Laminate

A material for forming the second solid electrolyte layers 42 is disposed on the surfaces of the positive electrode 3 on both sides on which the positive electrode mixture layers 31 are disposed, and then pressing is performed in this state to obtain a second solid electrolyte layer—positive electrode laminate. Although not particularly limited, an examples of a method for disposing the material for forming the second solid electrolyte layers 42 on the surfaces of the positive electrode 3 on both sides on which the positive electrode mixture layers 31 are disposed is a method in which the second solid electrolyte layers 42 are transferred onto the positive electrode mixture layers 31 by using second solid electrolyte layer transfer sheets. The second solid electrolyte layer transfer sheet is obtained in such a manner that a solid electrolyte having a median size of 1 μm or less, for example, is dispersed in a solvent to obtain a slurry, and the slurry is applied to a support sheet and, thereafter, is dried. Although not particularly limited, a pressing pressure is, for example, 10 MPa or more and 2000 MPa or less. Although not particularly limited, a pressing temperature is, for example, room temperature or more and 1500° C. or less.

### Electrode Laminate

The first solid electrolyte layer—negative electrode laminate and the second solid electrolyte layer—positive electrode laminate are disposed such that the surface of the first solid electrolyte layer—negative electrode laminate on a side on which the first solid electrolyte layer 41 is disposed faces the surface of the second solid electrolyte layer—positive electrode laminate on the side on which the second solid electrolyte layer 42 is disposed, and then pressing is performed in this state to obtain an electrode laminate. Although a pressing pressure is not particularly limited provided that the pressing pressure allows formation of the solid electrolyte layers 4 as integral bodies, the pressing pressure is, for example, 10 MPa or more and 2000 MPa or less. Although not particularly limited, a pressing temperature is, for example, room temperature or more and 1500° C. or less.

Although a device used in manufacturing the solid-state battery 1 is not particularly limited, examples of such a device include a roll press device and a flat plate pressing device.

Although not particularly limited, an example of the solid-state battery 1 is an all-solid-state lithium metal battery. Hereinafter, the case in which the solid-state battery 1 is an all-solid-state lithium metal battery will be described.

The negative electrode mixture layer 21 is a lithium metal layer. Although not particularly limited, an example of the negative electrode current collector 22 is a copper foil.

The positive electrode mixture layer 31 includes a positive electrode active material, and may further include a solid electrolyte, a conductive assistant, a binder, and the like. Although the positive electrode active material is not particularly limited provided that the positive electrode active material can absorb and discharge lithium ions, an example of the positive electrode active material is a lithium nickel cobalt manganese composite oxide. Although the solid electrolyte is not particularly limited provided that the solid electrolyte has lithium ion conductivity, examples of the solid electrolyte include an oxide-based electrolyte and a sulfide-based electrolyte. Although the conductive assistant is not particularly limited provided that the conductive assistant has electron conductivity, an example of the conductive assistant is a carbon black. Although the binder is not particularly limited provided that the binder can increase binding properties, an example of the binder is a styrene-butadiene rubber.

Although not particularly limited, an example of the positive electrode current collector 32 is an aluminum foil.

Each of the first solid electrolyte layer 41 and the second solid electrolyte layer 42 includes a solid electrolyte, and may further include a binder and the like. Although the solid electrolyte is not particularly limited provided that the solid electrolyte has lithium ion conductivity, examples of the solid electrolyte include inorganic solid electrolytes, such as an oxide-based electrolyte and a sulfide-based electrolyte. Solid electrolytes forming the first solid electrolyte layer 41 and the second solid electrolyte layer 42 may be either the same or different. Although the binder is not particularly limited provided that the binder can increase binding properties, an example of the binder is a styrene-butadiene rubber.

In the electrode laminate, an intermediate layer having a function of uniformly depositing lithium metal may be formed between the negative electrode 2 and the solid electrolyte layer 4. With such formation of the intermediate layer, an interface between the intermediate layer and the first solid electrolyte layer 41 is stabilized. In this case, the solid-state battery 1 may be an anode-free battery in which a lithium metal layer serving as the negative electrode mixture layer 21 is not yet formed when an initial charging is performed. In the anode-free battery, after an initial charging and discharging is performed, the lithium metal layer serving as the negative electrode mixture layer 21 is formed.

The intermediate layer includes metal that can be alloyed with lithium, and includes amorphous carbon. The intermediate layer may further include a binder and the like. It is preferable that the metal that can be alloyed with lithium, and the amorphous carbon be nanoparticles. Examples of the metal that can be alloyed with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). Examples of the amorphous carbon include carbon blacks, such as an acetylene black, a furnace black, and a Ketjen black, a coke, and an activated carbon. The amorphous carbon may be a graphitizable carbon (soft carbon), or may be a non-graphitizable carbon (hard carbon), a carbon nanotube (CNT), a fullerene, or a graphene. Although the binder is not particularly limited provided that the binder can increase binding properties, an example of the binder is a polyvinylidene fluoride (PVDF).

Although not particularly limited, the thickness of the intermediate layer is, for example, 1 μm or more and 10 μm or less.

Although the embodiment of the present invention has been described heretofore, the present invention is not limited to the above-mentioned embodiment, and the above-mentioned embodiment may be suitably changed within the gist of the present invention. For example, the solid-state battery 1 may further include an outer case (for example, a laminate film) that sheathes the electrode laminate.

### EXPLANATION OF REFERENCE NUMERALS

1 solid-state battery
2 negative electrode
21 negative electrode mixture layer
22 negative electrode current collector
3 positive electrode
31 positive electrode mixture layer
31a end portion
32 positive electrode current collector
32a positive electrode current collecting tab
4 solid electrolyte layer
41 first solid electrolyte layer
42 second solid electrolyte layer

What is claimed is:

1. A solid-state battery comprising:
an electrode laminate in which a negative electrode, a solid electrolyte layer, and a positive electrode are sequentially laminated, wherein
the solid electrolyte layer includes a first solid electrolyte layer and a second solid electrolyte layer, the first solid electrolyte layer being disposed on a side closer to the negative electrode, the second solid electrolyte layer being disposed on a side closer to the positive electrode,
the positive electrode includes a positive electrode current collector and a positive electrode mixture layer, and an inclined surface is formed at least at one end portion of the positive electrode mixture layer, and
when the electrode laminate is viewed in a top view from a lamination direction of the electrode laminate, an outer peripheral part of the first solid electrolyte layer is located outward of an outer peripheral part of the positive electrode mixture layer.

2. The solid-state battery according to claim 1, wherein when the electrode laminate is viewed in a top view from the lamination direction of the electrode laminate, an end portion of the positive electrode current collector on a side on which the inclined surface is formed is located outward of the outer peripheral part of the positive electrode mixture layer.

3. The solid-state battery according to claim 2, wherein the second solid electrolyte layer is formed on a surface of the positive electrode current collector at a portion at which no positive electrode mixture layer is formed.

4. The solid-state battery according to claim 1, wherein the first solid electrolyte layer in a region where the first solid electrolyte layer faces a region of the positive electrode mixture layer having no inclined surface has a higher density than the first solid electrolyte layer in a region where the first solid electrolyte layer does not face the region of the positive electrode mixture layer having no inclined surface.

5. The solid-state battery according to claim 1, wherein the second solid electrolyte layer in a region where the second solid electrolyte layer does not face a region of the positive electrode mixture layer having no inclined surface has a higher density than the first solid electrolyte layer in a region where the first solid electrolyte layer does not face the region of the positive electrode mixture layer having no inclined surface.

6. The solid-state battery according to claim 1, wherein when the electrode laminate is viewed in a top view from the lamination direction of the electrode laminate, the outer peripheral part of the first solid electrolyte layer is located outward of an outer peripheral part of the second solid electrolyte layer.

7. The solid-state battery according to claim 1, wherein the solid-state battery is an all-solid-state lithium metal battery.
